(19) United States
(12) Patent Application Publication
(10) Pub. No.: US 2024/0171407 A1
(43) Pub. Date: May 23, 2024

(54) IMPROVED METHODS & SYSTEMS FOR SIGNATURE VERIFICATION IN BLOCKCHAIN-IMPLEMENTED DATA APPLICATIONS

(71) Applicant: nChain Licensing AG, Zug (CH)

(72) Inventors: Craig Steven WRIGHT, London (GB); Jack Owen DAVIES, London (GB)

(21) Appl. No.: 18/283,193

(22) PCT Filed: Mar. 17, 2022
(86) PCT No.: PCT/EP2022/057094

§ 371 Date: Sep. 20, 2023

(30) Foreign Application Priority Data
Mar. 26, 2021 (GB) 2104312.0

(51) Int. Cl. H04L 9/32; H04L 9/00

(52) U.S. Cl. CPC H04L 9/3247; H04L 9/50

(57) ABSTRACT

Embodiments provide verification methods and systems for use in respect of data-oriented blockchain applications. In contrast to conventional signature verification in blockchain protocols, embodiments disclosed herein are performed in-situ within a single transaction, using only data that is provided within that transaction. Therefore, there is no reliance upon signatures provided from other transactions, and potential exploits such as replay attacks can be prevented. In an embodiment, this can be achieved by placing the signature in the output of the transaction rather than the locking script.

### CROSS REFERENCE TO RELATED APPLICATIONS

This application is the U.S. National Stage of International Application No. PCT/EP2022/057094 filed on Mar. 17, 2022, which claims the benefit of United Kingdom Patent Application No. 2104312.0, filed on Mar. 26, 2021, the contents of which are incorporated herein by reference in their entireties.

### TECHNICAL FIELD

The present disclosure relates to security and verification methods and systems, and in particular for security and verification operations performed in respect of blockchain transactions.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicized. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

As mentioned above, these blockchain models and their associated protocols can be used to form the basic, underlying platform upon which complex applications and systems can be built to provide additional functionality. As a result, blockchain-implemented technologies can be used to provide a wider range of technical benefits beyond just the transfer of cryptocurrencies. Numerous higher-level applications have been developed which utilise a blockchain and its associated protocol as the underlying mechanism which enables the storage and transfer of data and resources such as tokenised assets. One such example is the “Metanet” which provides a blockchain-based alternative to the conventional Internet for storing, structuring, indexing and sharing data. The Metanet protocol sits on top of the underlying blockchain network and associated protocol (bitcoinsv.io/wp-content/uploads/2020/10/The-Metanet-Technical-Summary-v1.0.pdf).

Such blockchain-implemented technologies need to ensure that the data they are transferring and processing are accessed only by authorised parties, and that they are not open to potential security vulnerabilities or exploits by malicious third parties. Therefore, there is a need for secure, flexible and efficient verification techniques which can be utilised by data-oriented applications and systems that are built upon blockchains.

### SUMMARY

According to one aspect disclosed herein, there is provided a signature verification technique which can be utilised to advantage by data applications which are implemented on top of an underlying blockchain. Such applications often store data within transactions on the blockchain, and signature verification relating to that data is essential to ensure its integrity and to prevent exploits and unauthorised activities. However, although signature verification is performed at the transaction level in accordance with the protocol of the underlying blockchain, this mechanism is sometimes insufficient for verification at the data application level because of the way that data is often stored within transactions and because the underlying blockchain protocol requires the verification of a signed message which includes data that is provided outside the transaction. Moreover, blockchain protocols typically require the use of a specific signature scheme, which may be restrictive or undesirable in certain data-oriented implementations.

Embodiments of the disclosure overcome at least these technical challenges by relocating the signature used by data application(s) from an input's unlocking script to elsewhere in the transaction, such as the output and removing the requirement for the signature to be validated by nodes of the Bitcoin network, using the Bitcoin scripting engine. In some embodiments, the signature may be moved to the locking script of the output, potentially after a command which terminates evaluation of the script such as OP_RETURN. The signature may be provided by signing a message which includes data uniquely identifying the transaction that it is located in, thus tying or associating the signature with the transaction and enabling the avoidance of potential exploits. Moreover, by providing a verification technique that is distinct from the signature verification mechanism of the underlying blockchain protocol, restrictions related to the use of specific signature schemes can be avoided. Efficiencies can also be gained because miners' resources such as processing and energy requirements are not needed for verification.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions.

FIG. 5 provides a simple example of a Metanet-implemented graph of nodes, each being suitable for storage of data and uniquely identifiable within the Metanet protocol by its Metanet index made up of a public key and a Metanet transaction ID.

FIG. 6 shows an example transaction TxID₁ and a previous transaction TxID₀ and the parts that are used as the message for signature verification in accordance with Case 1 as discussed below.

FIG. 7 shows an example transaction TxID₂ and the parts that are used as the message for signature verification in accordance with Case 2 as discussed below.

FIG. 8 shows an example transaction TxID₃ and the parts that are used as the message for signature verification in accordance with Case 3 as discussed below.

### DETAILED DESCRIPTION OF EMBODIMENTS

### Example System Overview

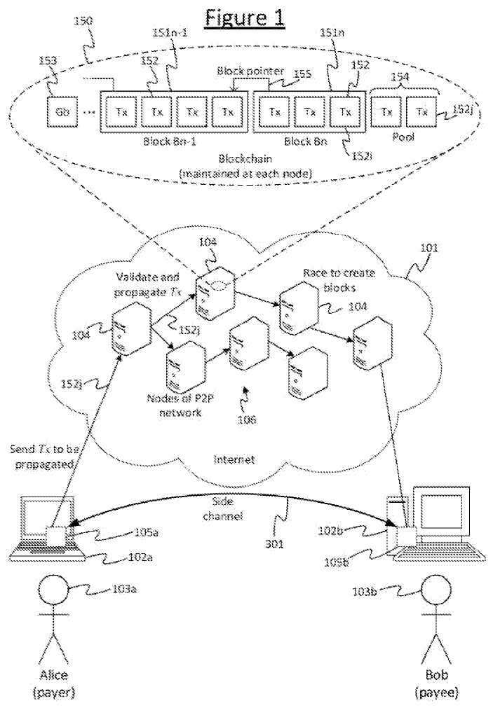

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again, if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically, this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore, this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee” and is discussed blow.

Due to the resources involved in transaction validation and publication, typically at least each of the blockchain nodes 104 takes the form of a server comprising one or more physical server units, or even whole a data centre. However, in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively, the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

UTXO-Based Model

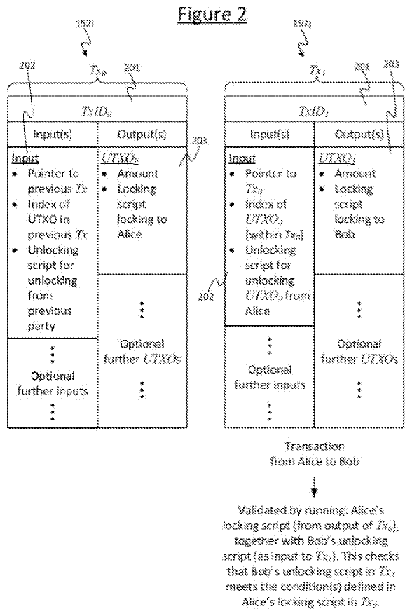

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively, Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (also known as scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:
<Sig P_{A}><P_{A}>∥[Checksig P_{A}]
where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore, such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However, the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead, any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively, or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically, an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance, this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively, or additionally, the side channel 107 may be used to exchange any other transaction related data, such as keys, negotiated amounts or terms, data content, etc.

The side channel 107 may be established via the same packet-switched network 101 as the blockchain network 106. Alternatively, or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

Client Software

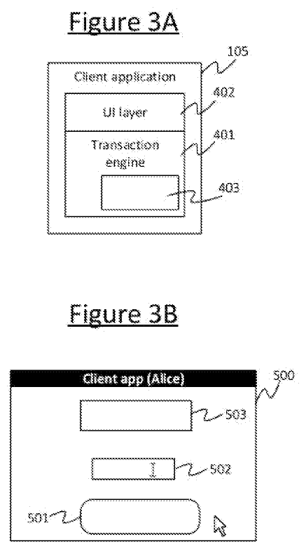

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 comprises a function 403 . . . .

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to . . . .

Alternatively, or additionally, the UI elements may comprise one or more data entry fields 502, through which the user can . . . . These data entry fields are rendered via the user output means, e.g. on-screen, and the data can be entered into the fields through the user input means, e.g. a keyboard or touchscreen. Alternatively, the data could be received orally for example based on speech recognition. Alternatively, or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

Node Software

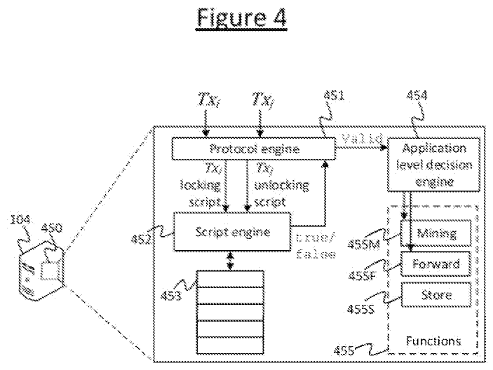

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise, it returns the result “false”.

In an output-based model, the result “true” from the script engine 452 is one of the conditions for validity of the transaction. Typically, there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance, in an account-based model, a result of “true” could be indicated by a combination of an implicit, protocol-level validation of a signature and an additional affirmative output of a smart contract (the overall result being deemed to signal true if both individual outcomes are true).

Disclosure Specific Material

As explained above, the protocol implemented by each blockchain node (i.e. “miner”) requires the node 104 to check that a cryptographic signature supplied in a new transaction 152j matches the signature specified in, and required by, a previous transaction 152i. In an output-based transaction protocol. The signature requirement is provided in the locking script of the output in the previous transaction, and the signature that fulfils that requirement is provided in the unlocking script of an input in the new transaction. Thus, the mining nodes 104 which make up the blockchain network's consensus mechanism perform a verification service, and reject any attempts to unlock an output if the signature in the next transaction's input does not meet the specified requirement. The conventional verification process, therefore, involves data (the message) which is provided separately by two different transactions because three inputs are needed for the verification process: the message, the signature generated using the private key, and the corresponding public key. In other words, the message used in miner-validated signatures is/can be split over separate transactions. So, when an output is locked, a locking script is created which includes the public key and the signature made using the corresponding private key. The portion of data that is signed to produce the signature is either the hash of the entire transaction data which includes the locked output, or part of it. In the latter case, the 1-byte SIGHASH flag is appended to the signature to indicate which part of the transaction data is included in the hash signed by the private key.

Bitcoin's SIGHASH algorithm achieves this by segmenting (known as “serialising”) transactions into chunks known as messages. These messages are signed using ECDSA signatures and included in unlocking scripts.

A key feature of the SIGHASH algorithm is that, when generating the serialised message for signing a particular transaction input, the message typically contains the previous outpoint and previous locking script being consumed in that input. This is important because it relates the signature to that specific transaction, thus preventing the signature from being copied and used within a different transaction.

As a result, though, the serialised message to be signed typically depends explicitly on the previous locking script. Crucially, it is necessary to ensure that this previous locking script was indeed part of the previous transaction. This can be achieved by verifying that the previous locking script was, indeed, part of the raw transaction Tx_{Prev} whose double hash produces TxID_{Prev}.

The full SIGHASH algorithm, as implemented in Bitcoin SV and with data types given in brackets, is written as:
1. nVersion in (4-byte little endian)
2. SHA256d of the serialisation of all input outpoints (32-byte hash)
   if ANYONECANPAY flag is set, then this should be a 32-byte zero.
3. SHA256d of the serialisation of nSequence of all inputs (32-byte hash)
   if ANYONECANPAY flag is set, then this should be a 32-byte zero.
4. the outpoint being spent (32-byte for transaction ID+4-byte little endian for index)
5. length in bytes of the subScript (big endian)
6. the subScript (defined below)
7. amount of the output in Satoshis (8-byte little endian)
8. nSequence of this outpoint (4-byte little endian)
9. SHA256d of the serialization of all output amounts and scriptPubKeys. These are taken from the outputs in.
   If SINGLE flag is set and the input index is smaller than the number of outputs, then this should be the double SHA256 of the output with scriptPubKey of the same index as the input
   If NONE flag is set, then this should be a 32-byte zero.
10. nLocktime of the transaction T (4-byte little endian)
11. sighash type of the signature (4-byte little endian)

Step 6 in the algorithm above is dependent on a subScript, which is generated using the previous unlocking scripts and prevOuts. The relationship between the previous transaction is as follows: “A new subScript is created from the previousScriptPubKey. The subScript starts from the most recent OP_CODESEPARATOR (the one just before the OP CHECKS IG that is [being executed]) to the end of the previousScriptPubKey. If there is no OP_CODESEPARATOR, the previousScriptPubKey becomes the subScript”—see wiki.bitcoinsv.io/index.php/OP_CHECKSIG

Moreover, in data-oriented applications which are built on top of Bitcoin and which use the Bitcoin ledger as an underlying data layer, there may be a need to apply signatures to the application data (rather than the transaction or outputs) in order to verify the authenticity of that data. For example, if an application notarises land registry on-chain, then it is beneficial to have a trusted land registry authority or notary sign the registration data.

For the purposes of efficient verification of the registry data, it would be beneficial for both the notarised data and the signature used for authenticity to exist in the same on-chain Bitcoin transaction. This is because it would allow for a user or verifier to obtain one Bitcoin transaction and both (i) obtain the notarised data and check its integrity and (ii) verify the signature over the data to check its authenticity.

In the ideal case, digital signatures used in such applications over Bitcoin should have the three following properties:
Verifiable in-situ—the signatures should be verifiable using only data taken from the transaction that contains them;
   this provides efficiency because less time and fewer resources are required to obtain the inputs for the verification process
Flexible signature algorithm—the signatures should be able to use any signature algorithm on an ad hoc basis (e.g. to aid quantum-resistance);
   this provides the advantage of a more flexible and versatile solution which is not constrained to using a particular scheme or algorithm but can instead choose to use a technique which suits the specific characteristics or requirements of the task at hand and
Non-replayable—a signature should only be valid for one Bitcoin transaction, i.e. the one in which it is initially provided;
   this provides the advantage of enhanced security, avoiding replay exploits and preventing signatures from being re-used in other transactions.

Prior to the advent of the present disclosure, it was possible to fulfil one or two of these properties using signatures in Bitcoin transactions, but not all three. Thus, a more versatile, efficient and secure arrangement is provided by embodiments of the disclosure. For the purposes of explanation and contrast, two example cases (Case 1 and 2 below) are provided, followed by an illustration of preferred embodiments of the disclosure (Case 3) which can be used to achieve all three properties.

Case 1: Script Signatures (Script)

A conventional method for signing data in Bitcoin transactions is to input signatures that are verified by script execution during transaction validation by the miners on the network. The signature is placed in the unlocking script of a subsequent (consuming) transaction TxID₁ for verification against the signature provided in the locking script of the previous (spending) transaction TxID₀.

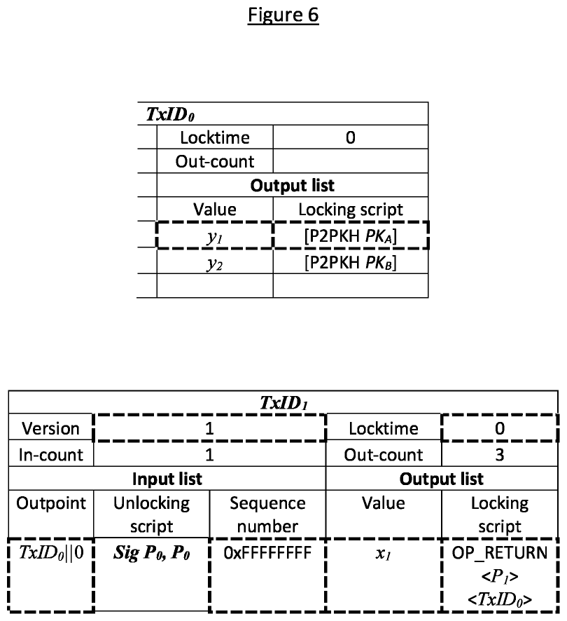

In this typical scenario, the message signed by the signature is formulated using the Bitcoin SIGHASH algorithm described above and the signatures are ECDSA signatures with DER encoding. The message that is signed includes the previous locking script and output value from TxID₀. In other words, this verification operation requires the use of data that is provided from the previous transaction. This is illustrated in FIG. 6 which shows an example transaction called TxID₁ that contains an input signature Sig P₀ in its unlocking script. The portions of TxID₀ (the previous transaction) and TxID₁ which are used as the message and digitally signed are shown in FIG. 6 within the dotted lines.

The fact that the SIG HASH flag forces the signature to sign part of the previous transaction means that these transactions cannot be verified in-situ just by using data that is obtainable or derivable solely from within TxID1. At least part of the data of TxID0 must also be fetched and may need to be integrity checked. Input signatures therefore fail to satisfy property 1 above. In addition, they are also limited to DER-encoded ECDSA signatures because they are dictated by the underlying blockchain protocol being implemented by the network's miners, which means they fail in property 2.

Therefore, case 1 only achieves property 3, because the signatures are verified in Bitcoin script and the blockchain's transaction validation mechanism will not allow signatures to be replayed in this manner.

Case 2: Non-Script Signatures (Data)

In this case, the signature is added to an output as additional data. Compared to Case 1, the signature has now been removed from the unlocking script of the input, and moved into the output. While the signature signs other data in the output, the signature itself is never verified by miners during transaction validation.

The signature can be verified in-situ because the message that is signed is entirely contained within, and derivable/obtainable within, Tx₁ itself. As the miners do not check the signature, it can also use any digital signature algorithm and a flexible encoding format.

However, because these signatures are simply data that is added to transactions, they can be copy-and-pasted into other transactions to replay them.

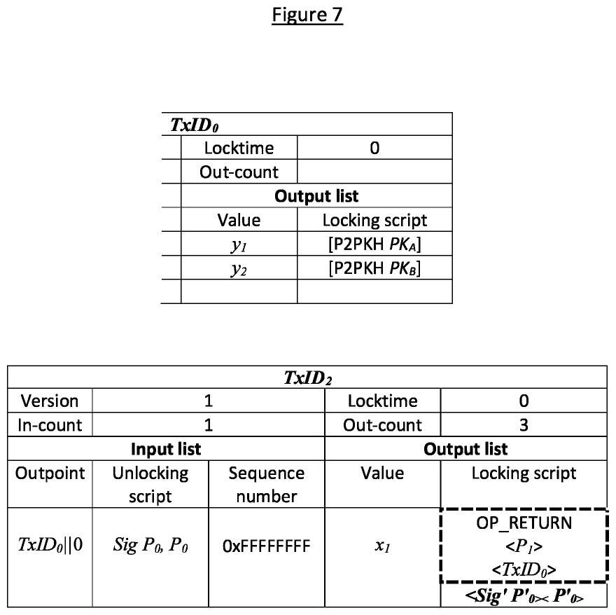

These types of signatures, therefore, achieve properties 1 and 2 only. To illustrate this case, FIG. 7 shows an example transaction TxID₂ containing an output signature Sig P₀′. The signed message is shown within the dotted line.

Case 3: Non-Replayable Signatures (Data)

We propose a third case, which may be termed “non-replayable signatures”, in accordance with embodiments of the present disclosure.

As with Case 2, these comprise non-script signatures, and therefore the signature has been removed from the unlocking script of the input of Case 1 and moved into the output. In addition, Case 3 requires that the signed message includes a portion of data which uniquely ties it to the transaction in which it is provided. In an embodiment, the portion of data is one or more outpoints contained within the transaction. Including the unique transaction-identifying data in the message means that the signature can only be verified with respect to Tx₁, and therefore cannot be replayed in a subsequent transaction. This is because each outpoint consumed by Tx₁ is unique to Tx₁. Therefore, these signatures satisfy property 3.

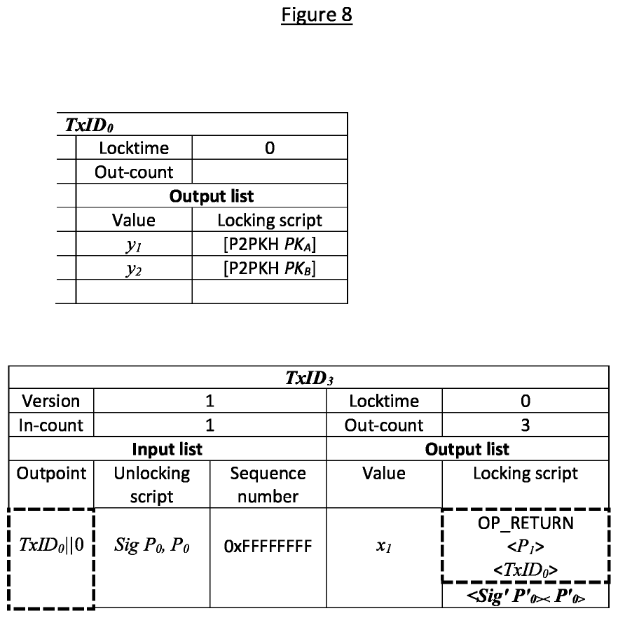

Because these are also non-script signatures, they also satisfy properties 1 and 2. Therefore this third case satisfies all three properties desirable for on-chain digital signatures used for signature verification at the data application-level. For illustration, FIG. 8 shows an example transaction TxID₃ containing an output signature Sig P₀″. The signed message is shown within the dotted line.

### Example Use Case—Metanet Transactions

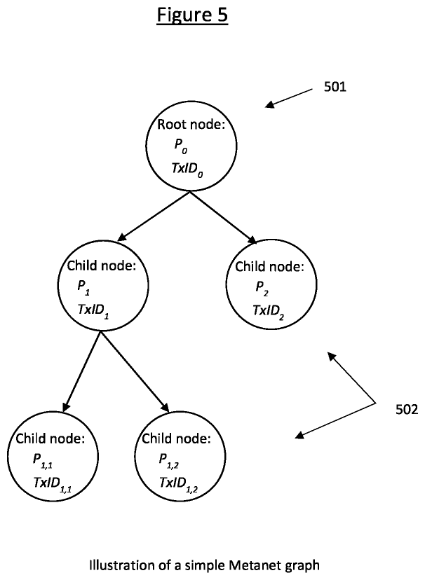

For the purpose of illustration and with reference to FIG. 5, we now provide a scenario showing an embodiment in use with a particular implementation. In this scenario, the underlying blockchain is the Bitcoin blockchain and the data-oriented application is formed in accordance with the Metanet protocol, substantially as disclosed in WO 2020/109908, the contents of which are incorporated herein in their entirety. Further information relating to the Metanet protocol can be found at wiki.bitcoinsv.io/index.php/The_Metanet. A more detailed explanation can also be found below in the section entitled “Metanet In More Detail”.

By way of summary, though, the Metanet is an application layer protocol which provides a blockchain-based alternative to the Internet for storing, structuring, accessing and indexing data. The data is stored in (or referenced from) transactions on the blockchain which we will refer to a nodes. Each Metanet node includes a flag to indicate that it is formed in accordance with the Metanet protocol and can, therefore, be identified by Metanet-based implementations. Each Metanet node also includes a public key (DPK) and a transaction ID (DTxID) which we will refer to as “discretionary” in the sense that they are provided in addition to, and separate from the public keys and transaction IDs that are required in accordance with the underlying blockchain (Bitcoin) protocol. The DPK and DTxID of a metanet node can be used in combination to serve as an index or address for a given portion of data within the Metanet, and enable the construction of logical hierarchies of associated transactions which form a graph-like structure of data-containing nodes. A very simple example of such a graph is shown in FIG. 5 for the purposes of illustration, although it will be appreciated that much more complex structures can be created. Nodes in the graph are structured into higher and lower hierarchical levels via edges. To create a child node 502 from a parent node 501, (i.e. a lower level node and a higher level node respectively) the edge between them is created using a valid signature derived from the parent node's key. In some implementations, a child can have one or more parents.

It is clear, then, that it is important in Metanet implementations (as well as other blockchain-implemented data applications) to be able to verify the signature and public key of a given node/transaction. In the conventional miner-based verification illustrated in Case 1 above, the signature is located in the unlocking script of an input within the parent node.

However, using the miner verification approach, this requires data from the locking script of the previous transaction's output, which may not be available to the verifying entity. If the reader/user/application does not explicitly perform or trigger the miner verification approach itself, then it would be possible to insert an invalid signature into the unlocking script of the node's transaction, and miners on the blockchain network would still accept this as valid. This is because the form of the unlocking script does not necessarily imply a specific form of the previous unlocking script (i.e. especially after Genesis upgrade on BSV, where notion of ‘standard’ script types was deprecated).

Therefore an unlocking script in a Metanet node that is ostensibly a valid signature and public key is not necessarily so, and would need to be explicitly checked using the miner verification approach to confirm. If this explicit check is not done, then the ostensible signature (and public key) could be non-valid, or just random any data formatted to look like a signature (and public key). As a result, an ostensible Metanet child node could be created that looks like a valid child node because it confirms to syntactical requirements of the blockchain protocol, but does not include a valid signature from the parent. This would not necessarily be rejected by miners, because the unlocking script containing the non-valid signature may still satisfy a particular unlocking script (e.g. locking script: OP_1 OP_DROP OP_DROP, unlocking script: <Fake Signature><Fake Public Key>).

Therefore, the conventional signature verification performed by Bitcoin miners at the UTXO verification level cannot be relied upon in this application-layer scenario.

Embodiments of the disclosure overcome this potential exploit by moving the Metanet signature from the input's unlocking script and adding it elsewhere in the transaction (preferably an output), thus removing the need to rely upon verification by the miners, and in turn removing the need to include data from outside the transaction itself in the signing message. The message can, now, be signed by any type of signature scheme. Moreover, the new verification approach is performed in-situ (i.e. using only data provided within the transaction itself, in a self-contained manner) without relying on signatures that are externally sourced, relative to the transaction. By de-coupling the Metanet signature verification from the underlying protocol implemented by the miners, we gain the advantage of not only preserving security but also providing a more flexible verification mechanism because the restriction to using one, specified type of signature scheme is removed.

Using such an embodiment, computer-based resources such as applications, bots, oracles etc. that implement data applications such as the Metanet can be arranged to perform the signature verification based on a signed message which is provided outside the unlocking script and which includes data that uniquely associates it with the transaction that it is located in.

This is a significant rearrangement of conventional miner-performed signature verification used in blockchains which, as the name indicates, requires the linking or chaining of one transaction to another via outputs to inputs which pass signatures between them to ensure that transmissions are being sent to the correct recipient. In accordance with embodiments, there is no chaining or dependency of signatures between separate transactions.

Metanet In More Detail

It has been explained in summary above how data can be inserted into the blockchain by providing it within transactions. For the sake of completeness and with reference to FIG. 5, we now present more detail relating to the Metanet protocol, which can be used for structuring transactions in logical way that allows for addressing of nodes, permissions, and content version control in a blockchain-implemented alternative to the internet. The aim of the structure described here is to
(i) Associate related content in different transactions to enable searching, identification and access to the data
(ii) Allow identification of content using human-readable keyword searches, to improve speed, accuracy and efficiency of searching
(iii) Build and emulate server-like structures within a blockchain

The Metanet approach is to structure data as a directed graph. The nodes and edges of this graph correspond to:
Node—A transaction associated with the Metanet protocol. A node stores content. (The terms “content” and “data” may be used interchangeably within this document).
A node is created by including an OP_RETURN that is immediately followed by <Metanet Flag>. Each node is assigned a public key P_{mode}. The combination of public key and transaction ID uniquely specify the index of the node ID_{node}:=H(P_{node}∥TxID_{node}).
The hash function used should be consistent with the underlying blockchain protocol that the invention is to be used with e.g. SHA-256 or RIPEMD-160 for Bitcoin.
Edge—An association of a child node with a parent node.
An edge is created when a signature Sig Pₚₐᵣₑₙₜ appears in the input of a Metanet transaction, and therefore only a parent can give permission to create an edge. All nodes may have at most one parent, and a parent node may have an arbitrary number of children. In the language of graph theory the indegree of each node is at most 1, and the outdegree of each node is arbitrary.
It should be noted that an edge is an aspect of the Metanet protocol and is not itself a transaction associated with the underlying blockchain.

A valid Metanet node (with parent) is given by a transaction of the following form:

TxID_{node}

| Input | Output |
|---|---|
| < Sig Pₚₐᵣₑₙₜ> <Pₚₐᵣₑₙₜ> | OP_RETURN <Metanet Flag> <P_{node}> |
| | <TxIDₚₐᵣₑₙₜ> |

This transaction contains all the information needed to specify the index of the node and its parent
ID_{node}=H(P_{node}∥TxID_{node}), IDₚₐᵣₑₙₜ=H(Pₚₐᵣₑₙₜ∥TxIDₚₐᵣₑₙₜ).

Note: a metanet node can have more than one parent, although we will used examples herein involving only one parent for simplicity of illustration. Moreover, since the signature of at least one parent node is required, only a parent can create an edge to a child. If the <TxIDₚₐᵣₑₙₜ> field is not present, or it does not point to a valid Metanet transaction, then the node is an orphan. It has no higher-level node by which it can be reached. Additional attributes may be added to each node. These may include flags, names and keywords. These are discussed below.

As shown, the index of a node (transaction) can be broken down into
a) Public Key P_{node}, which we interpret as the address of the node
b) Transaction ID TxID_{node}, which we interpret as the version of the node

Two advantageous features arise from this structuring:
1. Version control—If there are two nodes with the same public key, then we interpret the node with transaction ID with greatest proof of work as the latest version of that node. If the nodes are in different blocks, then this can be checked with the block height. For transactions in the same block, this is determined by the Topological Transaction Ordering Rule (TTOR).
2. Permissioning—A child of a node can only be created if the owner of the public key P_{node} signs the transaction input in the creation of a child node. Therefore P_{node} not only represents the address of a node but also the permission to create a child node. This is intentionally analogous to a standard bitcoin transaction—a public key in not only an address but also the permission associated with that address.
   Note that since the signature of the parent node appears in a UXTO unlocking script it is validated through the standard miner validation process at the point when the transaction is accepted to the network. This means that the permission to create a child node is validated by the bitcoin network itself.

The node and edge structure allow us to visualise the Metanet as a graph, as shown in FIG. 5.

Thus, the hierarchy of a Metanet graph allows rich domain-like structure to emerge. We interpret an orphan node as a top-level domain (TLD), a child of an orphan node as a sub-domain, a grandchild as a sub-sub-domain etc., and a childless node as an end-point.

The domain name is interpreted as ID_{node}. Each top-level domain in the Metanet may be thought of as a tree with the root being the orphan node and the leaves being the childless nodes. The Metanet itself is a global collection of trees which form a graph. The Metanet protocol does not stipulate that any node contains content data, but leaf (childless) nodes represent the end of a directed path on the data tree, and thus will be used generally to store content data. However, content may be stored at any node in the tree. Protocol-specific flags, included in nodes as attributes, may be used to specify the role of nodes in a data tree (disk space, folders, files or permissioning changes).

Recall that the Internet uses the Domain Name System (DNS) to associate human-readable names to Internet Protocol (IP) addresses. The DNS is in a sense decentralised, although in practice it is controlled by a small number of key players, such as governments and large corporations. Depending on your DNS provider the same name may take you to different addresses. This issue is inherent when mapping short human-readable names to computer generated numbers.

The Metanet uses an equivalent distributed system that maps a human-readable top-level domain name to the decentralised index IDᵣₒₒₜ of a root node. In other words, a 1-1 function K maps human-readable names to Metanet root node indexes, for example
K(‘bobsblog’)=ID_{bobsblog} (=H(P_{bobsblog}∥TXID_{bobsblog})).

The input to the left-hand-side is human-readable word, whereas the output on the right-hand-side is a hash digest, which will typically be a 256-bit data structure. Note that P bobsblog and TxID_{bobsblog} are also not human readable in general. In the standard IP protocol this would be a map from www.bobsblog.com to the IP address of the corresponding domain within the network.

The map K should be interpreted as a measure to ensure backwards-compatibility of the Metanet with the Internet in replicating the human-readability of DNS-issued domain names, but the naming and addressing scheme that provides the structure of the Metanet is not explicitly dependent on this map.

Possible existing forms of the mapping function K include the DNSLink system employed by Interplanetary File System (IPFS) or the OpenNIC service (www.openic.org). This mapping can be stored in an existing TXT record as part of the DNS. This is similar to a DNSLink in the IPFS—see docs.ipfs.io/guides/concepts/dnslink/. However, in general these sacrifice some element of decentralisation in order to provide a map that is 1-1—see hackernoon.conn/ten-terrible-attennpts-to-make-the-inter-planetary-file-system-human-friendly-e4e95df0c6fa

The public key used as the address of a Metanet node is not a human-readable object. This can make searching, referencing and inputting activities error prone and slow for human users. However, it is possible to create human-recognisable public key addresses—vanity addresses P_{vanity}—which include a plaintext prefix that can be interpreted directly by a user. Vanity addresses are known in the prior art.

The difficulty in creating such an address depends on the character length of the desired prefix. This means that human-recognisable vanity addresses may be used as node addresses that rely only on the effort of the owner to create rather than on central issuance. For a given prefix there exist many distinct vanity addresses, due to the characters remaining in the suffix, and hence many node addresses can share a common prefix whilst still retaining uniqueness. An example of a vanity address with a desirable prefix is

```
P_{bobsblog}: bobsblogHtKNngkdXEeobR76b53LETtpyT
  Prefix: bobsblog
  Suffix: HtKNngkdXEeobR76b53LETtpyT
```

The vanity address above may be used to sense check the map from the name ‘bobsblog’ to the node index ID_{bobsblog} and to aid the searchability of Metanet nodes by address. Note that the prefix is not unique here but the entire address itself is a unique entity.

The combination of a chosen address P_{vanity} with a TxID that together form ID_{node} is also beneficial as it means there is no central issuer of domain names (TxIDs are generated by decentralised proof-of-work) and the names are recoverable from the blockchain itself. Advantageously, there are no longer the points of failure that exist within the internet DNS.

Since Metanet domains already provide a permissions system (the public key) there is no need to issue a certificate to prove ownership. The use of a blockchain for this purpose has already been explored in namecoin (namecoin.org/) for example. In accordance with the present invention, however, there is no need to use a separate blockchain for this function as everything is achieved within one blockchain. This significantly reduces the amount of resources (hardware, processing resources and energy) required by the invention in comparison to the prior art. It also provides an entirely different architecture in terms of apparatus and arrangement of system components. An advantage of this naming system is that a user is able to identify a top-level domain in the Metanet by a memorable word (for example a company name) rather than a hash digest. This also makes searching for the domain faster as it is quicker to search for a keyword rather than a hash digest. It also reduces input errors, thus providing an improved searching tool for blockchain-stored data.

Given that there is a map from a domain name to a node index it is possible to build up a resource locator similar to that of a Uniform Resource Locator (URL) for the internet. This can be called a Metanet URL (MURL), and takes the form
MURL=‘mnp:’+′//domain name′+′/path′+′/file′.

Each of the components of a URL—protocol, domain name, path and file—have been mapped to the structure of a MURL, making the object more user-intuitive and enabling it to be integrated with the existing structure of the internet. This assumes that each node has a name associated with its public key (address) that is unique at the level within the domain tree. This name is always the right-most component of the MURL for a given node. If two nodes at the same level in the tree have the same name then they will have the same public key and so the latest version is taken.

Searching the Metanet

The above describes an embodiment the Metanet graph structure such that each node has a unique index and may have a name attributed to it. This allows for content to be located using a MURL. In order to also enable quick search functionality, the Metanet protocol allows for additional keywords to be attributed to a node. The fixed attributes of a node are the index and index of parent node, and the optional attributes are the name and keywords.

| Node attributes | |
|---|---|
| { | |
| index: | H(P_{node}\|\|TxID_{node}); |
| index of parent: | H(Pₚₐᵣₑₙₜ\|\|TxIDₚₐᵣₑₙₜ); (NULL if orphan) |
| name: | ‘bobsblog’; |
| kwd1: | ‘travel’; |
| kwd2: | ‘barbados’; |

```
    .
    .
    .
}
```

In one example, a practical method for searching the Metanet may be to first use a block explorer to trawl through the blockchain and identify all transactions with the Metanet flag, check that they are valid Metanet nodes, and if so record their indexes and keyword in a database or other storage resource. This database can then be used to efficiently search for nodes with desired keywords. Once the index of the node(s) with the desired keywords is found its content can be retrieved from the block explorer and viewed. Note also that the Metanet can incorporate a content addressable network (CAN) by storing a hash of the content stored by a node transaction as an additional attribute. This means Metanet nodes may also be indexed and searched for by content hash.

Browser-Wallet Application

Recall that in the Metanet protocol all data lives directly on the blockchain itself. Tools and applications can be built (which we will refer to for convenience only as a “browser-wallet”) that can efficiently access, display and interact with Metanet data stored on the blockchain.

The browser-wallet is an application intended to allow an end-user to interact with the Metanet infrastructure on the blockchain. This application should allow explorative searches of the Metanet graph for specific content embedded in trees. Additionally, the browser-wallet will handle retrieval, decryption, recombination and caching (optional) of content. The browser-wallet application combines these elements with cryptocurrency payment mechanisms by supporting a native (or external) wallet. The browser-wallet can comprise the following core elements:
Blockchain search engine—Support for a third-party search engine to query Metanet nodes by a variety of indexes including ID_{node}, node name, keywords, block height and TxID.
Display window—Software that unpacks content returned to the browser by a full-copy blockchain peer. This covers decryption, recombination, caching and redemption of access tokens.
Cryptocurrency wallet—Dedicated key-management for currency of the blockchain. Can be native to the application or authorised to communicate and synchronise with external wallet (software or hardware). Able to write standard blockchain transactions as well as new Metanet node transactions. Can mediate on-chain purchase of access keys and access tokens.
Hierarchical, deterministic key management is leveraged for both cryptocurrency public keys and Metanet node addresses.
Access key/token wallet—Dedicated key-management for purchased access keys or tokens. Can receive purchased keys or tokens using cryptocurrency wallet but has no permissions over them. They may be hidden to the user to allow later expiry. This may be achieved through the use of a trusted execution environment. Timed-access can be secured by synchronising with the blockchain and querying current block height.

The specification for the Metanet browser-wallet includes the following functionalities:
1. Hierarchical key-management—The keys used for controlling funds and managing Metanet trees (graphs) utilise the same hierarchical deterministic key infrastructure, reducing the burden on users to maintain key records for their Metanet content.
2. Pointing to an external cryptocurrency wallet—Ability to authorise and synchronise with an external (non-native to application) wallet allows for additional security by removing the browser-wallet as a point of failure. The application can write blockchain transactions and require the signature of an external wallet that houses keys, delegating this responsibility to separate software or hardware.
3. Searching of Metanet content—The browser-wallet can support and query a third-party search engine whose functions may comprise crawling, indexing, servicing and ranking Metanet node transaction data in a global database. A database of OP_RETURN transactions containing the Metanet protocol flag may be constructed. See BitDB 2.0—bitdb.network/.
   The search engine can serve the browser-wallet with a node index, which allows data to be found.
4. Reading and writing data to blockchain—In addition to using search engines and full-nodes to serve the browser with content, the support for a cryptocurrency wallet also allows for content to be written into the Metanet directly from the browser-wallet.
5. Decompression and decryption of data—The browser-wallet handles decryption keys and can perform decompression on Metanet content in-situ.
6. Caching node identities (ID node)—Unique node identities can be cached locally for more efficient lookup and querying.
7. Bypassing web-servers—Given a node index, the browser-wallet can query any full-copy member of the peer-to-peer (P2P) blockchain network for the content located at a node. Because the Metanet lives on-chain, any full-copy peer must have a local copy of the node and its content.
   This means that the user's browser-wallet need only query a single peer, which can be done directly and without the need for an intermediary web-server.
   FIG. 15 shows the schematic for the browser-wallet and how its core functions are split across different components of the application.

Metanet Search Engine

The browser-wallet application communicates with a third-party search engine for discovery of node identities (ID_{node}) A third-party may provide a service that replicates the capabilities of existing internet search engines. A Metanet search engine third-party maintains a database of all Metanet transactions mined into the blockchain identifiable by the Metanet protocol flag. This database can catalogue all Metanet nodes by a range indexes including ID_{node}, node names, key words, TxID and block height.

Services are known which continuously synchronise with the blockchain and maintain transaction data in a standard database format. The browser-wallet offloads the responsibilities of crawling, indexing, servicing and ranking Metanet transactions to such a third-party and makes a connection to their services when locating content stored on the Metanet graph.

Efficiency savings may be made by having a database that is dedicated to Metanet data only. Unlike Bit DB this would not store the data associated with all transactions, but only those containing the Metanet flag. Certain databases, such as non-relational databases like MongoDB, may be more efficient at storing the graph structure of the Metanet. This would allow for faster querying, lower storage space, and more efficiently associate related content within Metanet domains. The process is as follows
1. The end user inputs keywords into the browser-wallet search bar.
2. The browser-wallet sends the keyword query to a third-party SE.
3. The SE checks the keywords against its database and returns ID_{node} for any Metanet nodes containing relevant content. The third-party can also return other indexes on each node to the user, as well as providing suggestions for related content.
4. The browser-wallet uses the node identity and the domain name associated with it to construct a MURL.
5. The browser-wallet requests the content belonging to the specified node from any network peer with a full copy of the blockchain.
6. The network peer serves the browser-wallet with the requested content. Because the peer has a copy of the blockchain, they must also have a copy of the content and so only one request is made, and it is never forwarded to other network peers.

Content Display—Metanet Browser

The browser-wallet application emulates the same front-end capabilities that any typical web-browser should provide. These functions include, but are not limited to:
1. Searching—Provide access to a search engine (SE) for locating content.
2. Retrieval—Communicate with a server to facilitate the transfer of content using a known protocol e.g. Hypertext Transfer Protocol (HTTP).
3. Interpreting—Parsing raw code (e.g. in JavaScript) and executing.
4. Rendering—Efficient display of parsed content to be viewed by the end user.
5. User interface (UI)—Provide an intuitive interface for a user to interact with content, including action buttons and mechanism for user-input.
6. Storage—Local temporary storage capacity for caching internet content, cookies etc., to improve repeated access to content.

In certain embodiments, the software component of the browser-wallet application responsible for acting as a web-browser is able to perform the above functions on Metanet content embedded in the blockchain that is both searchable (using SEs) and retrievable (from peers) using their attributes.

In accordance with certain embodiments of the invention, the web-browser software component of the browser-wallet application is able to handle all operations that need to be performed on given Metanet content. There are many such operations that need to be performed in general, but we assume that at least the following are executed by the application using the Metanet protocol and infrastructure.
Recombination—In the case that Metanet content needs to be split up and inserted into multiple separate node transactions, the application will request the content from all relevant nodes and reconstitute the original content. The ordering and structure of the splintered content can be encoded using additional flags in each node's attributes.
Decompression—Where content data is stored on the blockchain in a compressed form, it should include a flag to indicate to the browser-wallet which standard compression scheme has been used. The application will decompress content according to this flag.
Decryption—Where content is encrypted a flag should be used to signify the encryption scheme. The application will locate a key from its decryption key wallet (as discussed below) and decrypt content data for use according to the encryption scheme used.

In performing these operations on content data, flags can be used to signify to the browser-wallet that a given operation needs to be performed. This generalises to any other operation, for which a suitable <operation_flag> can be included as part of the attributes of nodes to which the operation applies.

Caching

The caching of local files and cookies is a common and important function of typical web-browsers. The browser-wallet application also uses local storage in a similar way in order to optionally keep a record of ID_{node} and other node attributes that pertain to content of interest. This allows more efficient lookup and retrieval of content from frequently-visited Metanet nodes. The Metanet solves the problem inherent with caching internet data that it is mutable and can be changed or censored by web-browsing software depending on the provider. When caching Metanet data a user can always easily verify that it is in the same state as when originally included as an immutable record on the blockchain.

Cryptocurrency Wallet

Deterministic keys Dk are private keys initialized from a single “seed” key (See Andreas M. Antonopoulos, Chapter 5 in “Mastering Bitcoin” O'Reilly 2^{nd} Ed., 2017, pp. 93-98). The seed is a randomly generated number that acts as a master key. A hash function can be used to combine the seed with other data, such as an index number or “chain code” (see HD Wallets—BIP-32/BIP-44), to derive deterministic keys. These keys are related to one another and are fully recoverable with the seed key. The seed also permits the easy import/export of a wallet between different wallet implementations, giving an additional degree of freedom if the user wishes to use an external wallet in conjunction with the Metanet browser-wallet.

A hierarchical deterministic (HD) wallet is a well known derivation method of deterministic keys. In HD wallets, a parent key generates a sequence of children keys, which in turn derive a sequence of grandchildren keys, and so on. This tree-like structure is a powerful mechanism for managing several keys. In a preferred embodiment, a HD wallet can be incorporated into the Metanet architecture.

Advantageously, embodiments of the disclosure can directly merge the functionality of traditional web-browsers with one or more cryptocurrency wallets. This is fundamentally how the Metanet combines the payment for “internet” content with its delivery to the end user.

To achieve this, embodiments of the browser-wallet may have a dedicated, in-built software component that operates as a cryptocurrency wallet. This wallet is native the application itself and can be used to manage cryptocurrency private keys and authorise transactions as payment for Metanet content within the browser-wallet itself. This means that the browser component of the application can prompt the wallet component to authorise a payment that is required—by purchasing a decryption key, access token or otherwise—to view Metanet content. The application does not need to invoke an external third party to process the payment, and thus the Metanet content of interest is consumed by the application and paid for in-situ.

The same advantages and functionality can be achieved by embodiments of the application if a user wishes to instead manage or keep their cryptocurrency private keys on an external wallet (software or hardware) or even use multiple wallets. This may be performed in lieu of, or in conjunction with, the application's native wallet. In such embodiments, the application establishes a link or pairing with an external wallet(s), and synchronises with it, but does not store private keys in the browser-wallet itself. Instead, when the browser component prompts a payment to be made for content, the application requests an authorisation by digital signature from the external wallet of choice. This authorisation is made by the user and the browser-wallet can broadcast the transaction and view the paid content.

Reading and Writing Metanet Transactions

An intrinsic advantage of the Metanet is that it uses the same data-structure—the blockchain—to record both payments and content data. This means that software wallets can be used to write content data to the Metanet infrastructure in addition to creating transactions that are purely based on the exchange of cryptocurrency. The native wallet built-in to the application is able to write transactions to the blockchain that are more complex than typical simplified payment verification (SPV) clients—see bitcoin.org/en/glossary/simplified-payment-verification. The wallet allows users to choose to write a Metanet node transaction to the blockchain directly from the application by selecting content data, from their computer, to be embedded in the blockchain.

As the browser-wallet application has a user interface (UI) it allows for the wallet component to create and broadcast transactions that include content data that has be constructed either in the browser-component or on the user's computer beforehand. This capability would be far more difficult to achieve for a purpose-built wallet to handle on its own.

Access Key/Token Wallet

Recall from above that, built in to the Metanet protocol, is the ability to encrypt content using an ECC keypair or AES symmetric key, and the ability purchase the corresponding decryption key or token. We will refer to these as access keys or access tokens. Such keys/tokens grant the user permission to view or edit content (either single use or multi-instance use) and play a distinct role from keys that control the users cryptocurrency wallet (although the same key may be used for both purposes if desired). For this reason, it is advantageous to introduce a new wallet, separate from the application's native cryptocurrency wallet, that is used for storing and managing access keys and tokens.

One can also introduce the notion of timed access to Metanet content by allowing access keys/tokens to be burned after a certain time period. This can be achieved by requiring that access keys/tokens are stored in a Trusted Execution Environment (TEE) and are not directly accessible to the user.

The fact that access keys/tokens may be “burned” is also a motivating factor for not storing them in the cryptocurrency wallet to ensure there is no risk of cryptocurrency private keys being burned.

In a similar way to the cryptocurrency wallet, decryption keys and access tokens can be stored and managed deterministically to facilitate efficient handling and deployment. Decryption keys (e.g. ECC private keys) can be generated and recovered by subsequent additions to a master key, while access tokens can be reconstructed using a hash chain that is seeded by some initial token.

It is important to make the distinction here that the cryptocurrency wallet handles the deterministic key generation for key pairs that are used in transacting with other users and creating new Metanet nodes, whereas a key/token wallet(s) handles keys and tokens that have been purchased by the cryptocurrency wallet.

Block Height Permissioning

Timelocks can be included in the bitcoin script language to enable block height permissioning. The op_code OP_CHECKLOCKTIMEVERIFY (CLTV) sets the block height at which a transaction output (UTXO) is permissible for spending.

The advantages of block height permissioning are twofold:
1. Version control—In the Metanet Protocol, the newest version of a node can be identified from the node at the greatest block height. The browser-wallet can be set up to only display the most recent version of a file by block height, allowing proof-of-work version control.
2. Timed access—The Browser-wallet application can periodically burn the decryption keys atomically purchased by the user. This ensures that viewers can only access content data during the time period for which they have paid. Cloning of the decryption keys can be prevented by storing them in a trusted execution environment (TEE). Moreover, the atomic swap involves the purchase of a deterministic key Dk (for decryption of the content data). Although this deterministic key is publicly visible, the TEE can be used to sign for the combination of Dk and a securely enclaved private key.

The browser-wallet can be arranged to synchronise with the current state of the blockchain in order to use block height as its own proxy for time, rather than relying on any external clock or third-party time oracle.

### CONCLUSION

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However, it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

### STATEMENTS RELATING TO ILLUSTRATIVE EMBODIMENTS OF THE DISCLOSURE

Embodiments of the disclosure may be described as verification and/or security methods/systems. Additionally, or alternatively, they may be described as methods/systems for controlling the transfer of a digital asset via a blockchain.
step.
Statement 1: A method for verifying a signature provided within a blockchain transaction, comprising:
   providing the signature within the blockchain transaction and/or verifying it, wherein the signature is based on a message which:
      comprises transaction identification data for uniquely identifying the transaction; and
      contains only data that is derivable and/or obtainable from within the transaction.
Statement 2. A method according to statement 1, wherein:
   i) the message is digitally signed; and/or
   ii) at least part of the message is encrypted or encoded; and/or
   iii) the signature is provided within the transaction at a location other than an unlocking script; and/or
   iii) the signature and/or message is provided within an output of the transaction; preferably, it may be provided in a locking script of the transaction; the locking script may be provided within, or in association with, the output of the transaction.
Statement 3. A method according to statement 1 or 2 wherein:
   i) the transaction identification data comprises or relates to an outpoint or other portion of data uniquely associated with the transaction; and/or
   ii) the transaction identification data is encoded, hashed or obfuscated.
Statement 4. A method according to any preceding statement and further comprising:
   i) performing a verification operation on the signature; and/or
   ii) using the message and a public key to perform a verification operation on the signature.
Statement 5. A method according to any preceding statement and comprising the step:
   using a computer-based resource to verify the signature, wherein the computer-based resource is not arranged to perform mining and/or verification operations in accordance with an underlying protocol associated with the blockchain.
Statement 6. A method according to any preceding statement and further comprising:
   digitally signing, encoding or encrypting the message using a cryptographic key.
Statement 7. A method according to any preceding statement and further comprising:
   permitting an action if verification of the signature succeeds or prohibiting an action if verification of the message fails.
Statement 8. A method according to any preceding statement wherein:
   the blockchain transaction is formed in accordance with an application-level protocol.
Statement 9. A method according to statement 8 wherein the protocol is:
   arranged to facilitate the association of blockchain transactions to form a logical hierarchy of blockchain transactions; and/or a blockchain-implemented metanet protocol.
Statement 10. A method according to any preceding statement and comprising:
   using the signature and public key in a comparison against a further signature generated using the public key or performing a verification by comparing the public key against a further public key.
Statement 11. A method according to any preceding statement wherein the transaction identification data comprises an outpoint.
Statement 12. A blockchain-implemented verification method comprising:
   generating or providing a blockchain transaction comprising:
      i) a message that comprises:
         transaction identification data for uniquely identifying the transaction; and
         only data that is derivable and/or obtainable from within the transaction;
      and
      ii) a digital signature which is related to, based on or generated using the message.
Statement 13. A blockchain-implemented verification method according to statement 12 wherein:
   i) the transaction further comprises a public key related to the cryptographic key used to generate the signature; and/or
   iii) the transaction identification data comprises an output; and/or
   ii) the signature is generated by digitally signing the message using a cryptographic key that is related to the public key; and/or
   iv) the signature is provided outside any input associated with the transaction.
Statement 14. A method of verifying a digital signature provided in a blockchain transaction (Tx) that comprises:
   the digital signature to be verified;
   a message which:
      i) comprises transaction identification data for uniquely identifying the transaction; and
      ii) contains only data that is derivable and/or obtainable from within the transaction;
   a transaction ID (TxID);
   a protocol flag;
   a discretionary public key (DPK); and
   a discretionary transaction ID (DTxID).
Statement 15. A method according to statement 14, wherein the transaction (Tx) further comprises:
   a portion of stored data, or a reference to a portion of stored data.
Statement 16. A method according to statement 14 or 15, wherein:
   the portion of stored data or reference to a portion of stored data, the protocol flag, the discretionary public key (DPK) and/or the discretionary transaction ID (DTxID) are provided within an output (UTXO) of the transaction, preferably within a locking script associated with the output (UTXO).
Statement 17. A method according to statements 14 to 16 wherein the portion of stored data, reference to the portion of stored data, the protocol flag, the discretionary public key (DPK) and/or the discretionary transaction ID (DTxID) are provided within the transaction (Tx) at a location following a script opcode for marking an output as invalid for subsequent use as an input to a subsequent transaction.
Statement 18. A method according to statements 14 to 17, wherein:
   the transaction (Tx) further comprises one or more attributes; preferably wherein:
   the one or more attributes comprises a keyword, tag or identifier associated with:
   i) a portion of data provided within or referenced within the transaction (Tx); and/or
   ii) the transaction (Tx).
Statement 19. A method according to statements 13 to 17 wherein the transaction (Tx) further comprises:
   a parent public key (PPK) associated with a logical parent transaction (LPTx), wherein the logical parent transaction (LPTx) is identified by the discretionary transaction ID (DTxID); and
   the signature is generated using the parent public key (PPK).
Statement 20. A method according to statements 13 to 18, and further comprising the step of:
   using the discretionary public key (DPK) and the transaction ID (TxID) to identify the transaction (Tx) or the logical parent transaction within a blockchain.
Statement 21. A method according to statements 14 to 20, wherein the protocol flag is associated with and/or indicative of a blockchain-based protocol for searching for, storing in and/or retrieving data in one or more blockchain transactions.
Statement 22. Computer equipment comprising:
   memory comprising one or more memory units; and
   processing apparatus comprising one or more processing units, wherein the memory stores code arranged to run on the processing apparatus, the code being configured so as when on the processing apparatus to perform the method of any of statements 1 to 21.
Statement 23. Computer equipment according to statement 22 wherein the equipment:
   i) is or is arranged or operative to interact with a blockchain network and/or blockchain-implemented system; and/or
   ii) comprises a hardware wallet.
Statement 24. A computer program embodied on computer-readable storage and configured so as, when run on one or more processors, to perform the method of any of statements 1 to 21.
Statement 25. A blockchain-implemented method according to any of statements 1 to 21, and comprising:
   using or providing a hardware and/or software component to perform any of statements 1 to 21; wherein the hardware and/or software component is or comprises:
      a cryptocurrency wallet;
      a search engine;
      a blockchain explorer; or
      a browser;
and preferably wherein the component is operative to perform a simplified payment verification (SPV) operation.

According to an another aspect disclosed herein, there may be provided a computer implemented method and corresponding system. These may be described as methods/systems for verifying a (cryptographic) signature. The signature may be used within a transaction (node) formed in accordance with a blockchain-based protocol such as, for example, the Metanet protocol. The Metanet protocol may be substantially as disclosed within GB2007238.5 or WO 2020/109908, both of which are incorporated herein in their entirety. Any feature(s) described below in respect of this, or other, aspects pf the disclosure may be combined with the methods set out in one or more of the statements provided above.

A method in accordance with this aspect of the disclosure may be described as a method for enabling or controlling the processing, storing, retrieving, identifying and/or sharing of data via a blockchain. Additionally, or alternatively, it may be described as a method for associating or linking data stored within (separate/different) blockchain transactions to enable the identification, retrieval and/or sharing of said data. Additionally, or alternatively, it may be described as a method for verifying a cryptographic signature. The method may include the step of processing at least one blockchain transaction (Tx) comprising a transaction ID (TxID), comprising:
a protocol flag;
a discretionary public key (DPK); and
a discretionary transaction ID (DTxID).

This combination of features enables portions of data to be identified on a blockchain, and also to be linked/associated with one another when provided in a plurality of transactions. It enables a graph or tree-like structure to be constructed, which reflects the hierarchical relationships between portions of data, facilitating their processing, searching, access, generation and sharing. Herein, “sharing” may include providing to a node or user, sending, communicating, transmitting or providing access to the portion of data.

The transaction ID (TxID) is the identifier for the transaction as known in the art of blockchain protocols—each blockchain transaction has a unique ID as part of the underlying blockchain protocol. By contrast, the discretionary public key (DPK) and/or the discretionary transaction ID (DTxID) may be “discretionary” in that they are provided as part of the present invention rather than essential component(s) of the transaction as dictated by the protocol of the underlying blockchain. Put another way, they are not required in order for the transaction to be valid in accordance with the protocol of the underlying blockchain eg Bitcoin. Additionally or alternatively, they may be described as additional, non-essential items which are provided as part of the present invention, not because the blockchain protocol requires them.

Preferably, the protocol flag is associated with and/or indicative of a blockchain-based protocol for searching for, storing in and/or retrieving data in one or more blockchain transactions. The protocol flag may be an indicator or marker. It may indicate that the transaction is formed in accordance with a pre-determined protocol. This may be a protocol other than the protocol of the underlying blockchain. It may be a search protocol in accordance with any embodiment described herein (i.e. what may be referred to as the “metanet” protocol described herein).

The term “processing” may be interpreted as meaning any activity relating to the transaction or its associated data, including generating, transmitting, validating, accessing, searching for, sharing submitting to a blockchain network, and/or identifying.

The discretionary transaction ID may be an identifier, label, indicator or tag which is associated with the transaction (Tx) in accordance with an embodiment of the present invention. We use the term “indicator” to include all of these terms. It should be noted that, as known in the art and readily understood by the skilled addressee, each transaction on a blockchain is uniquely identified by an identifier, typically referred to in the art as the TxID. The TxID is an essential, required and non-discretionary part of the underlying blockchain protocol. This non-discretionary TxID is not to be confused with the discretionary transaction ID (DTxID) as referred to herein.

Preferably, the blockchain transaction (Tx) further comprises a portion of data, or a reference to a portion of data. The reference to the portion of data may be a pointer, address or other indicator of a location where the data is stored. The portion of data may be any type of data or digital content e.g. a computer-executable item, text, video, images, sound file etc. The portion of data may be referred to as “content”. The portion of data or the reference to it may be in a processed form. For example, it may be a hash digest of the portion of data. The data may be stored on the blockchain or off it (i.e. “off chain”). Preferably, the portion of data or reference to a portion of data, the protocol flag, the discretionary public key (DPK) and/or the discretionary transaction ID (DTxID) are provided within an output (UTXO) of a blockchain transaction. One or more of them may be provided within a locking script associated with the output (UTXO).

Preferably, the portion of data, reference to the portion of data, the protocol flag, the discretionary public key (DPK) and/or the discretionary transaction ID (DTxID) are provided within the transaction (Tx) at a location following a script opcode for marking an output as invalid for subsequent use as an input to a subsequent transaction.

This script opcode may be the OP_RETURN opcode in one or more variants of the Bitcoin protocol, or may be a functionally similar/equivalent opcode from another blockchain protocol.

Preferably, the transaction (Tx) further comprises one or more attributes. This enables a more detailed approach to searching for data/content. The attributes may also be referred to as “values”, “labels” or “tags” or “identifiers”. They may be used to describe or annotate the portion of data, or provide additional information relating to the portion of data. Preferably, the one or more attributes comprises a keyword, tag or identifier associated with: i) a/the portion of data provided within or referenced within the transaction (Tx); and/or ii) the transaction (Tx).

Preferably, the transaction (Tx) further comprises: at least one parent public key (PPK) associated with a respective logical parent transaction (LPTx) that is identified by the discretionary transaction ID (DTxID); and a signature generated using the at least one parent public key (PPK).

This enables a logical hierarchy to be constructed between the transactions and their embedded data. There may be one parent public key associated with a child node (i.e. the child node has a single parent node) or more than one parent public key (i.e. a child node may have more than one parent). Thus, a plurality of associated or logically linked transactions on the blockchain can be processed efficiently, securely and quickly. The logically associated transactions may not be stored on the blockchain at contiguous block heights but they can be identified and/or accessed easily and securely. Preferably, the method further comprises the step of using the discretionary public key (DPK) and the transaction ID (TxID) to identify the transaction (Tx) or the logical parent transaction(s) within a blockchain.

Additionally, embodiments may comprise the steps: associating a public key with a blockchain transaction (Tx) which comprises a transaction ID; and searching for the blockchain transaction (Tx) based on the transaction ID and the transaction public key. This may provide an improved solution for storing, searching, identifying, communicating and/or accessing data via a blockchain. It may provide improvements for data communication and exchange across an electronic network, specifically a peer-to-peer blockchain network. Any feature(s) described herein may also be utilised in accordance with this embodiment of the disclosure (and vice versa) but are not re-recited or reproduced here for the sake of brevity and clarity. It may further comprise the step of accessing or otherwise processing a portion of data provided within or referenced from the transaction (Tx).

The public key and/or transaction ID may be discretionary as described herein. The transaction may comprise a transaction ID (TxID), a protocol flag; a discretionary public key (DPK); and a discretionary transaction ID (DTxID). The transaction (Tx) may further comprise a portion of data, or a reference to a portion of data. The portion of data or reference to a portion of data, the protocol flag, the discretionary public key (DPK) and/or the discretionary transaction ID (DTxID) may be provided within an output (UTXO), preferably within a locking script associated with the output (UTXO).

The portion of data, reference to the portion of data, the protocol flag, the discretionary public key (DPK) and/or the discretionary transaction ID (DTxID) may be provided within the transaction (Tx) at a location following a script opcode for marking an output as invalid.

The transaction (Tx) may comprise one or more attributes. The one or more attributes may comprise a keyword, tag or identifier associated with: i) a portion of data provided within or referenced within the transaction (Tx); and/or ii) the transaction (Tx).

The transaction (Tx) may comprise: at least one parent public key (PPK) associated with a respective logical parent transaction (LPTx), wherein the at least one logical parent transaction (LPTx) is identified by the discretionary transaction ID (DTxID); and a signature generated using the respective parent public key (PPK).

Embodiments may comprise: using the discretionary public key (DPK) and the transaction ID (TxID) to identify the transaction (Tx) or the logical parent transaction(s) within a blockchain. This may be performed during a searching step. The protocol flag may be associated with and/or indicative of a blockchain-based protocol for searching for, storing in and/or retrieving data in one or more blockchain transactions.

Additionally, embodiments of the disclosure may include steps for identifying a transaction (TX) in a blockchain, comprising the step of mapping a mnemonic to: a public key (PK) associated with the transaction (TX); and the transaction ID (TX ID) of the transaction (TX).

The steps may also comprise: i) using the public key (PK) and the transaction ID (TX ID) as operands to an operation to produce an output, and mapping the mnenonic to the output; ii) hashing the output prior to mapping the mnemonic. The operation may be a concatenation operation. The public key (PK) may comprise a human-readable prefix.

Additionally, embodiment(s) of the disclosure may include steps for identifying a target transaction on a blockchain. These may include using a search path to identify the target transaction, the search path comprising:
i) a root transaction index (RTIndex) comprising a public key (RTPK) associated with the root transaction and an ID (RTID) associated with the root transaction; and
ii) at least one attribute associated with the root transaction and/or the target transaction.

The at least one attribute may be null. The root transaction index (RTIndex) may comprise a hash of a function of the public key (RTPK) and the ID (RTID). The function may be a concatenation. At least one of the attributes may be a mnemonic associated with the root transaction or the target transaction. The root transaction and/or the target transaction may comprise a protocol flag. It may also comprise the steps of: i) using a block explorer to identify, in the blockchain, at least one transaction which comprises the protocol flag; and/or ii) identifying, in the blockchain, at least one transaction which comprises the protocol flag and storing data related to the at least one transaction in an off-blockchain resource. Preferably, the data related to the at least one transaction comprises: at least one index associated with the transaction; at least one index associated with another transaction which is linked to the transaction; and/or a keyword associated with the transaction. Embodiment(s) may also comprise: accessing a portion of data stored in, or referenced from, the target transaction.

Additionally, embodiments of the disclosure may include a computer-implemented system arranged to enable a user to search for, access, view, write and/or retrieve a portion of data provided in at least one blockchain transaction (Tx), wherein: the system is arranged to identify the at least one transaction (Tx) based on a transaction index (TX_{index}) comprising a transaction ID and a public key associated with the transaction (Tx).

The system may comprise a search facility which is: provided within the blockchain search system; or arranged to interface and/or communicate with the blockchain search system. It may comprise at least one cryptocurrency wallet. The at least one wallet may be arranged to: 1) generate, store and/or process hierarchical deterministic keys; and/or 2) to store at least one cryptographic key and/or at least one token in a Trusted Execution Environment. The system may comprise: a decompression component arranged to decompress the portion of data if it is compressed; a recombination component; and/or a decryption component arranged to decrypt the portion of data if it is encrypted. The system may comprise at least one presentation component arranged to present the portion of data to a user in an audible and/or visual form. The system may comprise: means for inputting or generating a search path to identify the at least one transaction (Tx) on the blockchain, wherein the search path comprises: i) the transaction index (TX_{index}); and ii) at least one attribute associated with the transaction (Tx). At least one of the attributes may be a mnemonic associated with the transaction; and/or the at least one attribute may be null. The system may be operative to communicate with a cryptocurrency wallet or other resource to facilitate processing, storage and/or generation of cryptographic keys, blockchain transactions and/or digital signatures. It may be operative to store the transaction index (TX_{index}), preferably wherein the system is arranged to store respective transaction indices for more than one transaction. It may be operative to: i) transfer control of a portion of cryptocurrency to a destination prior to accessing the portion of data; ii) send a request, to a peer on the blockchain, for the portion of data; and/or iii) receive the portion of data from a peer on the blockchain. It may be operative to use a time lock mechanism to control access to the portion of data.

Additionally, embodiments of the disclosure may provide step(s) for transferring an asset from a resource to a further resource, including: sending, from the resource to the further resource: complete transaction data relating to at least one blockchain transaction; and the complete Merkle path of the at least one blockchain transaction. The resource and/or further resource may comprise: a digital wallet, a cryptocurrency wallet, or a lightweight or Simplified Payment Wallet; and/or a computer-based device comprising a wallet; and/or a smart card comprising a wallet. It may comprise the step of storing, receiving and/or generating, at or on the resource: at least one private key; and/or at least one public key; and/or receiving, at the resource, at least one block header.

It may comprise the step of: providing, by the resource to the further resource, transfer data comprising: i) data relating to at least one unspent blockchain transaction output (UTXO); ii) a transaction ID (TXID) for a transaction containing the at least one unspent blockchain transaction output (UTXO); iii) a signature for spending the at least one unspent blockchain transaction output (UTXO); iv) a Merkle path for a transaction containing the at least one unspent blockchain transaction output (UTXO); and/or a public key address.

According to another aspect disclosed herein, there may be provided a system comprising computer equipment including:
memory comprising one or more memory units; and
processing apparatus comprising one or more processing units, wherein the memory stores code arranged to run on the processing apparatus, the code being configured so as when on the processing apparatus to perform the method of any of claims, method steps or embodiments included herein.

The computer equipment may be or may be arranged or operative to interact with a blockchain network and/or blockchain-implemented system; and/or may comprise a hardware wallet. The wallet may be arranged to perform an SPV (simplified payment verification) operation.

Embodiments also provide a computer program embodied on computer-readable storage and configured so as, when run on one or more processors, to perform any method, claim or embodiment included herein.

Embodiments also provide a blockchain-implemented method of using or providing a hardware and/or software component to perform any claim, method, step or embodiments included herein. The hardware and/or software component may be or may comprise: a cryptocurrency wallet; a search engine; a blockchain explorer; and/or a browser. The component may be arranged or operative to perform a SPV (simplified payment verification) operation.

Embodiments of the disclosure may include one or more features substantially as disclosed within WO 2020/109908 and PCT/162020/050737, both of which are incorporated herein in their entirety.

1. A method for verifying a signature provided within a blockchain transaction, comprising:
providing the signature within the blockchain transaction and/or verifying it, wherein the signature is based on a message which:
comprises transaction identification data for uniquely identifying the transaction and contains only data that is derivable and/or obtainable from within the transaction.

2. The method of claim 1, wherein:
i) the message is digitally signed; and/or
ii) at least part of the message is encrypted or encoded; and/or
iii) the signature is provided within the transaction at a location other than an unlocking script; and/or
iii) the signature and/or message is provided within an output of the transaction, preferably in a locking script of the transaction.

3. The method of claim 1 wherein:
i) the transaction identification data comprises or relates to an outpoint or other portion of data uniquely associated with the transaction; and/or
ii) the transaction identification data is encoded, hashed or obfuscated.

4. The method of claim 1 and further comprising:
i) performing a verification operation on the signature; and/or
ii) using the message and a public key to perform a verification operation on the signature.

5. The method of claim 1 and comprising the step:
using a computer-based resource to verify the signature, wherein the computer-based resource is not arranged to perform mining and/or verification operations in accordance with an underlying protocol associated with the blockchain.

6. The method of claim 1 and further comprising:
digitally signing, encoding or encrypting the message using a cryptographic key.

7. The method of claim 1 and further comprising:
permitting an action if verification of the signature succeeds or prohibiting an action if verification of the message fails.

8. The method of claim 1 wherein:
the blockchain transaction is formed in accordance with an application-level protocol.

9. The method of A method according to claim 8 wherein the protocol is:
arranged to facilitate the association of blockchain transactions to form a logical hierarchy of blockchain transactions; and/or
a blockchain-implemented metanet protocol.

10. The method of claim 1 and comprising:
using the signature and public key in a comparison against a further signature generated using the public key; or
performing a verification by comparing the public key against a further public key.

11-13. (canceled)

14. A method of verifying a digital signature provided in a blockchain transaction (Tx) that comprises:
the digital signature to be verified;
a message which:
i) comprises transaction identification data for uniquely identifying the transaction and
ii) contains only data that is derivable and/or obtainable from within the transaction;
a transaction ID (TxID);
a protocol flag;
a discretionary public key (DPK); and
a discretionary transaction ID (DTxID).

15. The method of claim 14, wherein the transaction (Tx) further comprises:
a portion of stored data, or a reference to a portion of stored data.

16. The method of claim 15, wherein:
the portion of stored data or reference to a portion of stored data, the protocol flag, the discretionary public key (DPK) and/or the discretionary transaction ID (DtxID) are provided within an output (UTXO) of the transaction, preferably within a locking script associated with the output (UTXO).

17. The method of claim 15, wherein the portion of stored data, reference to the portion of stored data, the protocol flag, the discretionary public key (DPK) and/or the discretionary transaction ID (DtxID) are provided within the transaction (Tx) at a location following a script opcode for marking an output as invalid for subsequent use as an input to a subsequent transaction.

18. The method of claim 14, wherein:
the transaction (Tx) further comprises one or more attributes; wherein:
the one or more attributes comprises a keyword, tag or identifier associated with:
i) a portion of data provided within or referenced within the transaction (Tx); and/or
ii) the transaction (Tx).

19. The method of claim 14 wherein the transaction (Tx) further comprises:
a parent public key (PPK) associated with a logical parent transaction (LPTx), wherein the logical parent transaction (LPTx) is identified by the discretionary transaction ID (DTxID); and
the signature is generated using the parent public key (PPK).

20. The method of claim 19, and further comprising the step of:
using the discretionary public key (DPK) and the transaction ID (TxID) to identify the transaction (Tx) or the logical parent transaction within a blockchain.

21. The method of claim 14, wherein
the protocol flag is associated with and/or indicative of a blockchain-based protocol for searching for, storing in and/or retrieving data in one or more blockchain transactions.

22. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method for verifying a signature provided within a blockchain transaction, comprising:
providing the signature within the blockchain transaction and/or verifying it, wherein the signature is based on a message which:
comprises transaction identification data for uniquely identifying the transaction, and
contains only data that is derivable and/or obtainable from within the transaction.

23. (canceled)

24. A computer program embodied on non-transitory computer-readable storage media and configured so as, when run on one or more processors, the one or more processors perform a method for verifying a signature provided within a blockchain transaction, comprising:
providing the signature within the blockchain transaction and/or verifying it, wherein the signature is based on a message which:
comprises transaction identification data for uniquely identifying the transaction; and
contains only data that is derivable and/or obtainable from within the transaction.

25. (canceled)
